(19) United States
(12) Patent Application Publication
(10) Pub. No.: US 2025/0116778 A1
(43) Pub. Date: Apr. 10, 2025

(54) METHODS AND DEVICES FOR ONLINE MEASUREMENT OF BINOCULAR LASER SYSTEMS

(71) Applicant: NORTHWESTERN POLYTECHNICAL UNIVERSITY, Xi'an (CN)

(72) Inventors: Pengfei GAO, Xi'an (CN); Xinshun LI, Xi'an (CN); Mei ZHAN, Xi'an (CN); Hongwei LI, Xi'an (CN); Xiaoguang FAN, Xi'an (CN); Xinggang YAN, Xi'an (CN)

(73) Assignee: NORTHWESTERN POLYTECHNICAL UNIVERSITY, Xi'an (CN)

(21) Appl. No.: 18/901,243

(22) Filed: Sep. 30, 2024

(30) Foreign Application Priority Data
Oct. 8, 2023 (CN) 202311289296.9

(51) Int. Cl. G01S 17/89; B23K 26/08; G01B 11/24; G01S 7/481

(52) U.S. Cl. CPC G01S 17/89; B23K 26/0869; G01B 11/24; G01S 7/4814

(57) ABSTRACT

Disclosed is a method and a device for online measurement of a binocular laser system. The method may include: mounting a workpiece and a measuring block, such that lasers emitted from a first and a second laser instrument are projected onto two measuring surfaces of the measuring block, and projection positions of the lasers emitted from the first and second laser instruments are maintained unchanged; and performing at least one round of cyclic operations until a forming process of the workpiece ends. The cyclic operations may include: acquiring a plurality of pieces of point cloud data, and separating point cloud data to obtain a first, a second, a third, and a fourth point cloud data set; generating a rigid matching relationship; generating a coordinate system relationship; converting the fourth point cloud data set into a fifth point cloud data set; and generating an intermediate shape and size of the workpiece.

### CROSS-REFERENCE TO RELATED APPLICATIONS

This application claims priority to Chinese Patent Application No. 202311289296.9, filed on Oct. 8, 2023, the entire contents of which are incorporated herein by reference.

### TECHNICAL FIELD

The present disclosure relates to the field of intelligent manufacturing technology, and in particular, to a method and a device for online measurement of a binocular laser system.

### BACKGROUND

A binocular laser system utilizes laser instruments positioned on two sides of a formed workpiece to obtain point cloud coordinates of contours of a first side and a second side of the workpiece. By employing point cloud processing techniques, the binocular laser system acquires shape and dimensional parameters of the workpiece, enabling real-time monitoring of the shape and size evolution during a forming process. Due to its ability to monitor and control the forming accuracy and quality of the workpiece, the binocular laser system is gradually being applied to online measurement of complex workpiece formations.

In the binocular laser system, the point cloud coordinates obtained by two laser instruments are based on their respective measurement coordinate systems, often necessitating coordinate system transformations. Therefore, it is common practice to calibrate a relative positional relationship between the measurement coordinate systems of the two laser instruments using a standard thickness gauge before measurement. However, external factors such as vibrations of a machine tool during forming may cause changes in the spatial position of the laser instruments, resulting in changes in the relative positional relationship between point cloud data, leading to deviations between a pre-calibrated point cloud coordinate transformation relationship and an actual situation, thereby generating measurement errors in the shape and size of the workpiece.

Additionally, since a laser profiler is sensitive to lighting conditions, differences in external lighting conditions between calibration and measurement may lead to different point cloud coordinates of a surface of an object, which may render the pre-calibrated point cloud coordinate transformation relationship of the two laser instruments unsuitable for the point cloud data obtained during measurement, also resulting in measurement errors in the shape and size of the workpiece.

In order to address the accuracy issues of point cloud data from laser instruments during measurement, CN113516695A discloses a point cloud registration strategy in laser profiler flatness measurement. By algorithmically extracting boundaries of the point cloud to obtain more effective key points, invalid key points are eliminated to obtain preliminary matched point pairs. Subsequently, clustering is performed on the feature-matched point pairs based on their geometric consistency to achieve coarse registration of the point cloud. Finally, fine registration of the point cloud is achieved based on boundary point clouds using an iterative closest point (ICP) algorithm. However, this method only focuses on the problem of point cloud data matching, unable to comprehensively improve testing accuracy of laser instruments from multiple dimensions.

Therefore, it is desirable to provide a method and a device for online measurement of a binocular laser system to improve the measurement accuracy of the binocular laser systems during measurement.

### SUMMARY

One or more embodiments of the present disclosure provide a method for online measurement of a binocular laser system. The method may include: mounting a workpiece on the binocular laser system, providing a measuring block fixing mechanism on the binocular laser system, and mounting a measuring block, such that a laser emitted from a first laser instrument and a laser emitted from a second laser instrument of the binocular laser system are projected onto two measuring surfaces of the measuring block, respectively, and a projection position of the laser emitted from the first laser instrument and a projection position of the laser emitted from the second laser instrument are maintained unchanged; and performing at least one round of cyclic operations until a forming process of the workpiece ends, and obtaining a shape and a size of the workpiece during the forming process and a shape and a size of the workpiece after the forming process, respectively. Each round of the at least one round of cyclic operations may include: acquiring a plurality of pieces of point cloud data measured by the first laser instrument and the second laser instrument during the forming process of the workpiece, and separating point cloud data characterizing the measuring block in the plurality of pieces of point cloud data and point cloud data characterizing the workpiece in the plurality of pieces of point cloud data to obtain a first point cloud data set and a second point cloud data set measured by the first laser instrument, and to obtain a third point cloud data set and a fourth point cloud data set measured by the second laser instrument, wherein the first point cloud data set is a first side point cloud data set of the measuring block in a coordinate system in which the first laser instrument is located, the second point cloud data set is a first side point cloud data set of the workpiece in the coordinate system in which the first laser instrument is located, the third point cloud data set is a second side point cloud data set of the measuring block in a coordinate system in which the second laser instrument is located, and the fourth point cloud data set is a second side point cloud data set of the workpiece in the coordinate system in which the second laser instrument is located; generating a rigid matching relationship of the measuring block based on the first point cloud data set and the third point cloud data set; generating a coordinate system relationship between the first laser instrument and the second laser instrument based on the rigid matching relationship; converting the fourth point cloud data set into a fifth point cloud data set based on the coordinate system relationship, the fifth point cloud data set being a second side point cloud data set of the workpiece in the coordinate system in which the first laser instrument is located; and generating an intermediate shape and an intermediate size of the workpiece based on the second point cloud data set and the fifth point cloud data set.

One or more embodiments of the present disclosure provide a device for online measurement of a binocular laser system. The device may include a mounting module and a cycling module. The mounting module may be configured to mount a workpiece on the binocular laser system, provide a measuring block fixing mechanism on the binocular laser system, and mount a measuring block, such that a laser emitted from a first laser instrument and a laser emitted from a second laser instrument of the binocular laser system are projected onto two measuring surfaces of the measuring block, respectively, and a projection position of the laser emitted from the first laser instrument and a projection position of the laser emitted from the second laser instrument are maintained unchanged. The cycling module may be configured to perform at least one round of cyclic operations until a forming process of the workpiece ends, and obtain a shape and a size of the workpiece during the forming process and a shape and a size of the workpiece after the forming process, respectively. The cycling module may include an acquisition and separation sub-module, a first generation sub-module, a second generation sub-module, a conversion sub-module, and a third generation sub-module. The acquisition and separation sub-module may be configured to acquire a plurality of pieces of point cloud data measured by the first laser instrument and the second laser instrument during the forming process of the workpiece, and separate point cloud data characterizing the measuring block in the plurality of pieces of point cloud data and point cloud data characterizing the workpiece in the plurality of pieces of point cloud data to obtain a first point cloud data set and a second point cloud data set measured by the first laser instrument, and to obtain a third point cloud data set and a fourth point cloud data set measured by the second laser instrument, wherein the first point cloud data set is a first side point cloud data set of the measuring block in a coordinate system in which the first laser instrument is located, the second point cloud data set is a first side point cloud data set of the workpiece in the coordinate system in which the first laser instrument is located, the third point cloud data set is a second side point cloud data set of the measuring block in a coordinate system in which the second laser instrument is located, and the fourth point cloud data set is a second side point cloud data set of the workpiece in the coordinate system in which the second laser instrument is located. The first generation sub-module may be configured to generate a rigid matching relationship of the measuring block based on the first point cloud data set and the third point cloud data set. The second generation sub-module may be configured to generate a coordinate system relationship between the first laser instrument and the second laser instrument based on the rigid matching relationship. The conversion sub-module may be configured to convert the fourth point cloud data set into a fifth point cloud data set based on the coordinate system relationship, the fifth point cloud data set being a second side point cloud data set of the workpiece in the coordinate system in which the first laser instrument is located. The third generation sub-module may be configured to generate an intermediate shape and an intermediate size of the workpiece based on the second point cloud data set and the fifth point cloud data set.

One or more embodiments of the present disclosure provide a non-transitory computer-readable storage medium storing computer instructions, wherein when reading the computer instructions from the storage medium, a computer implements the method for online measurement of the binocular laser system.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram of a binocular laser system according to some embodiments of the present disclosure;

FIG. 2 is a flowchart of an exemplary process for online measurement of a binocular laser system according to some embodiments of the present disclosure;

FIG. 3 is a schematic diagram of an exemplary process for determining a target measuring block position based on a prediction model according to some embodiments of the present disclosure;

FIG. 4 is a schematic diagram of a coordinate system relationship between a first laser instrument and a second laser instrument according to some embodiments of the present disclosure;

FIG. 5 is a flowchart of an exemplary process for determining a first point cloud data set, a second point cloud data set, a third point cloud data set, and a fourth point cloud data set according to some embodiments of the present disclosure;

FIG. 6 is a schematic diagram of separation of a plurality of pieces of point cloud data obtained by a first laser instrument according to some embodiments of the present disclosure; and

FIG. 7 is a schematic diagram of exemplary modules of a device for online measurement of a binocular laser system according to some embodiments of the present disclosure.

In the drawings: 100 denotes a binocular laser system; 110 denotes a machine tool; 120 denotes a first fixing mechanism; 130 denotes a first laser instrument; 140 denotes a workpiece; 150 denotes a measuring block fixing mechanism; 151 denotes an L-shaped support rod; 151-1 denotes a first link; 151-2 denotes a first elbow joint; 151-3 denotes a second link; 151-4 denotes a second elbow joint; 152 denotes a vertical rod; 160 denotes a measuring block; 170 denotes a second laser instrument; 180 denotes a second fixing mechanism; and 190 denotes a posture adjustment mechanism.

### DETAILED DESCRIPTION

In order to more clearly illustrate the technical solutions of the embodiments of the present disclosure, the accompanying drawings to be used in the description of the embodiments will be briefly described below. Obviously, the accompanying drawings in the following description are only some examples or embodiments of the present disclosure, and that the present disclosure may be applied to other similar scenarios in accordance with these drawings without creative labor for those of ordinary skill in the art. Unless obviously acquired from the context or the context illustrates otherwise, the same numeral in the drawings refers to the same structure or operation.

It should be understood that “system,” “device,” “unit,” and/or “module” as used herein is a way to distinguish between different components, elements, parts, sections, or assemblies at different levels. However, these words may be replaced by other expressions if they accomplish the same purpose.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

Flowcharts are used in the present disclosure to illustrate the operations performed by the system according to some embodiments of the present disclosure. It should be understood that the operations described herein are not necessarily executed in a specific order. Instead, the operations may be executed in reverse order or simultaneously. Additionally, one or more other operations may be added to these processes, or one or more operations may be removed from these processes.

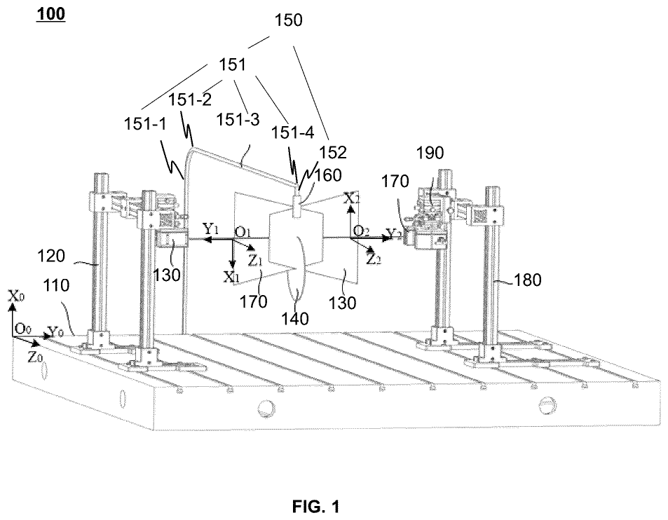

FIG. 1 is a schematic diagram of a binocular laser system according to some embodiments of the present disclosure. A binocular laser system 100 may also be referred to as a binocular laser measurement system.

In some embodiments, the binocular laser system 100 may include a machine tool 110, a first fixing mechanism 120, a first laser instrument 130, a workpiece 140, a measuring block fixing mechanism 150, a measuring block 160, a second laser instrument 170, a second fixing mechanism 180, and a posture adjustment mechanism 190.

In some embodiments, the binocular laser system 100 may further include one or more of a processing device, a storage device, a network, a user terminal, a vibration sensor and/or a light detection device (not shown in the drawings).

The machine tool 110 is a power device used to support an operation of the binocular laser system 100. The machine tool 110 may be configured to perform mechanical processing on a metal or non-metal material, for example, a cutting process, a non-cutting process, etc. For illustrative purposes, some embodiments of the present disclosure are described using spinning and pressing in the non-cutting process as an example. It should be noted that in actual use, the binocular laser system 100 may also be applied to other machining processes.

In some embodiments, the remaining components of the binocular laser system 100 may be set above the machine tool 110. In some embodiments, a shape of the machine tool 110 may be rectangular, square, circular, elliptical, etc. It should be noted that the machine tool 110 shown in FIG. 1 is for illustration purposes only and may differ from an actual shape of the machine tool 110. The actual shape of the machine tool 110 may be adjusted as needed.

The first fixing mechanism 120 is a component used to fix the first laser instrument 130. In some embodiments, the first fixing mechanism 120 may be mounted above the machine tool.

The first laser instrument 130 is a precision device that uses a high-precision laser displacement sensor to real-time monitor contour change data of a measured object in a non-contact way. In some embodiments, the first laser instrument 130 may emit a laser to a workpiece to be measured and receive a change in reflected light, thereby obtaining a shape and a size of the workpiece. The first laser instrument 130 may also be referred to as the first laser profiler.

The workpiece 140 refers to a part to be processed using the binocular laser system for measurement. In some embodiments, a material of the workpiece 140 may be metal, plastic, paper, glass, etc. A dimension of the workpiece 140 may be selected according to actual conditions. For example, in some embodiments of the present disclosure, the workpiece 140 may be made of 1060 aluminum alloy with a radius of 110 mm.

The measuring block fixing mechanism 150 refers to a component used to fix the measuring block 160.

In some embodiments, the measuring block fixing mechanism 150 may include an L-shaped support rod 151 and a vertical rod 152. The L-shaped support rod 151 may include a first link 151-1, a first elbow joint 151-2, a second link 151-3, and a second elbow joint 151-4. The first elbow joint 151-2 may be configured to connect the first link 151-1 and the second link 151-3, allowing the second link 151-3 to rotate about a main axis of the first link 151-1. The second elbow joint 151-4 may be configured to connect the L-shaped support rod 151 and the vertical rod 152, allowing the vertical rod 152 to rotate about a main axis of the vertical rod 152. Lengths of the first link 151-1, the second link 151-3, and the vertical rod 152 may be adjustable, enabling a position of the measuring block 160 to be adjusted.

In some embodiments, the measuring block fixing mechanism 150 may be mounted above the machine tool 110.

The measuring block 160 is an unscaled standard end face gauge. In some embodiments, the measuring block 160 may be configured as an intermediate standard gauge in a dimension transfer system. In some embodiments, a manufacturing material of the measuring block 160 may be a special alloy steel, with a cuboid structure having two mutually parallel and extremely smooth measuring surfaces among six planes, with a precise working dimension between the two measuring surfaces. In some embodiments, the two measuring surfaces of the measuring block 160 may be perpendicular to measurement planes of the first laser instrument 130 and the second laser instrument 170, respectively, and a distance between the two measuring surfaces (i.e., the working dimension) may be denoted as h.

In some embodiments, the measuring block 160 may be used to calibrate the positions of the first laser instrument 130 and the second laser instrument 170. In some embodiments, the measuring block 160 may be mounted on the measuring block fixing mechanism 150.

The function of the second laser instrument 170 is similar to that of the first laser instrument 130, and is not further described here. The second laser instrument 170 may also be referred to as the second laser profiler. In some embodiments of the present disclosure, the first laser instrument and the second laser instrument may be Keyence LJ-X8400.

In some embodiments, the second laser instrument 170 may be arranged opposite to the first laser instrument 130 and used together to measure the shape and size of the workpiece 140. In some embodiments, as shown in FIG. 1, the positions of the first laser instrument 130 and the second laser instrument 170 on the machine tool 110 are relative, i.e., the first laser instrument 130 and the second laser instrument 170 are disposed on two sides of the workpiece.

The second fixing mechanism 180 is a component used to fix the second laser instrument 170. In some embodiments, the second fixing mechanism 180 may be mounted above the machine tool 110.

The posture adjustment mechanism 190 is a component used to adjust positions and orientations of components in the binocular laser system 100 that require posture adjustment (e.g., the first laser instrument 130 and the second laser instrument 170). The posture adjustment mechanism 190 may also be referred to as a laser profiler posture adjustment mechanism.

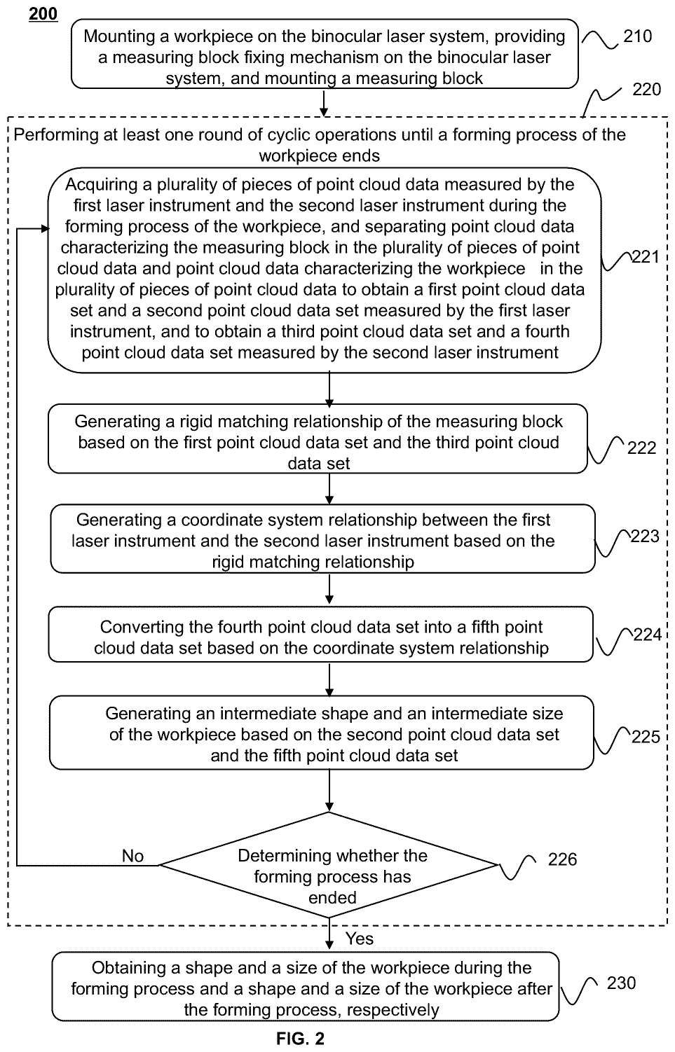

In some embodiments, the posture adjustment mechanism 190 may be used to adjust a posture of the first laser instrument 130 and a posture the second laser instrument 170 to make measurement axes of the first laser instrument 130, the second laser instrument 170, and the machine tool 110 parallel in various directions of a measurement coordinate system, and to make measurement planes of the first laser instrument 130 and the second laser instrument 170 coplanar. More descriptions of the measurement coordinate system may be found in FIG. 2 and the related descriptions thereof.

In some embodiments, the posture adjustment mechanism 190 may be mounted on the first laser instrument 130 and the second laser instrument 170.

The processing device is used for data processing and instruction execution in the binocular laser system 100. For example, the processing device may obtain vibration data from a vibration sensor. More descriptions of the vibration sensor and the vibration data may be found in the following descriptions.

In some embodiments, the processing device may be a single server or a server group. The server group may be centralized or distributed. In some embodiments, the processing device may be integrated into the binocular laser system or remotely set up. In some embodiments, the processing device may be implemented on a cloud platform. For example, the cloud platform may include a private cloud, a public cloud, a hybrid cloud, a community cloud, a distributed cloud, an inter-cloud, a multi-cloud, or any combination thereof.

The storage device is used to store data, instructions, and/or any other information of the binocular laser system 100. For example, the storage device may be used to store point cloud data measured by the first laser instrument 130 and the second laser instrument 170. More descriptions of obtaining point cloud data may be found FIG. 2 and the related descriptions thereof.

In some embodiments, the storage device may include one or more storage components, each storage component may be an independent device or part of another device. In some embodiments, the storage device may include a random access memory (RAM), a read-only memory (ROM), or any combination thereof. In some embodiments, the storage device may be implemented on a cloud platform. In some embodiments, the storage device may be part of the processing device.

The network may include any suitable network capable of facilitating information and/or data exchange. In some embodiments, at least one component (e.g., the processing device, the user terminal, the storage device, the first laser instrument, etc.) of the binocular laser system 100 may exchange information and/or data with at least one other component of the binocular laser system 100 via the network. For example, the processing device may obtain a preset time interval from the user terminal via the network. More descriptions of the processing device obtaining the preset time interval from the user terminal may be found in FIG. 2 and the related descriptions thereof.

The user terminal may communicate and/or connect with the processing device and/or the storage device 140. In some embodiments, the processing device may interact with a user via the user terminal. In some embodiments, the user terminal may include a mobile device, a tablet, a laptop, or any combination thereof. In some embodiments, the user terminal device (or all or part of its functions) may be integrated into the processing device.

The vibration sensor is a device used to collect vibration data. In some embodiments, the vibration sensor may be configured to collect vibration data during a forming process of the workpiece.

The vibration data refers to data related to the vibration of the workpiece during the forming process. For example, the vibration data may include a vibration frequency, a vibration amplitude, a vibration acceleration, etc.

The light detection device is a device used to detect ambient light data during the forming process of the workpiece.

In some embodiments, the light detection device may be configured to collect ambient light intensity during the forming process of the workpiece. In some embodiments, the light detection device may be any device capable of detecting ambient light intensity, such as a photoresistive sensor, a photodiode sensor, a fiber optic sensor, etc.

The ambient light intensity refers to energy of visible light received by the workpiece per unit area during the forming process.

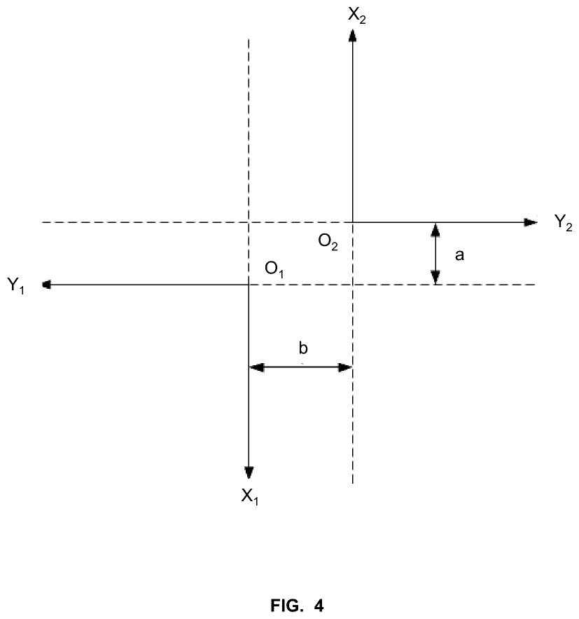

More descriptions of the functions of the above components may be found in FIGS. 2-7 and the related descriptions thereof.

Through the coordinated cooperation of various components, measurement accuracy of the binocular laser system can be achieved intelligently and automatically, improving measurement precision, making the forming process of the workpiece more efficient, and enhancing the quality of the processed workpiece.

FIG. 2 is a flowchart of an exemplary process for online measurement of a binocular laser system according to some embodiments of the present disclosure. As shown in FIG. 2, process 200 includes the following operations. In some embodiments, one or more operations of process 200 shown in FIG. 2 may be implemented in the binocular laser system 100 shown in FIG. 1. For example, process 200 shown in FIG. 2 may be stored in the form of instructions in a storage device and called and/or executed by a processing device.

In 210, a workpiece may be mounted on the binocular laser system, a measuring block fixing mechanism may be provided on the binocular laser system, and a measuring block may be mounted on the binocular laser system. In some embodiments, operation 210 may be performed by a mounting module 710.

In some embodiments, the processing device may control a robotic arm to mount the workpiece on the binocular laser system, provide the measuring block fixing mechanism, and mount the measuring block on the binocular laser system, such that a laser emitted from a first laser emitter and a laser emitted from a second laser emitter of the binocular laser system are projected onto two measuring surfaces of the measuring block, respectively, and a projection position of the laser emitted from the first laser emitter and a projection position of the laser emitted from the second laser emitter are maintained unchanged. The projected position refers to a position where the laser is projected onto the measuring surface of the block.

It should be noted that it is necessary to ensure that the measuring block is mounted at a position that is within a measuring range of the first laser instrument and a measuring range the second laser instrument and does not interfere with the forming process of the workpiece. More descriptions of the binocular laser system 100 and its components may be found in FIG. 1 and the related descriptions thereof.

In some embodiments, as shown in FIG. 1, on the machine tool 110, the processing device may control the robotic arm to dispose the first laser instrument 130 and the second laser instrument 170 on two sides of the workpiece 140 and ensure that the workpiece 140 is within the common measurement range of the first laser instrument 130 and the second laser instrument 170.

In some embodiments, the processing device may control the robotic arm to use the measuring block fixing mechanism 150 to mount two rectangular blocks within the measuring range of the first laser instrument 130 and the measuring range of the second laser instrument 170 without interfering with the processing process of the workpiece 140. A distance between measuring surfaces of the two rectangular blocks may be denoted as h. During the mounting process, the processing device needs to ensure that the two measuring surfaces of the measuring block 160 are perpendicular to measurement planes of the first laser instrument 130 and the second laser instrument 170, respectively. Since the two measuring surfaces of the measuring block 160 are perpendicular to the measurement planes of the first laser instrument 130 and the second laser instrument 170, a position of the measuring block may indirectly affect a posture of the first laser instrument 130 and a posture of the second laser instrument 170, thereby influencing a ratio of workpiece point cloud data, measuring block point cloud data, and unrecognized region point cloud data in the subsequent collected point cloud data. Therefore, it is necessary to determine a position of the measuring block.

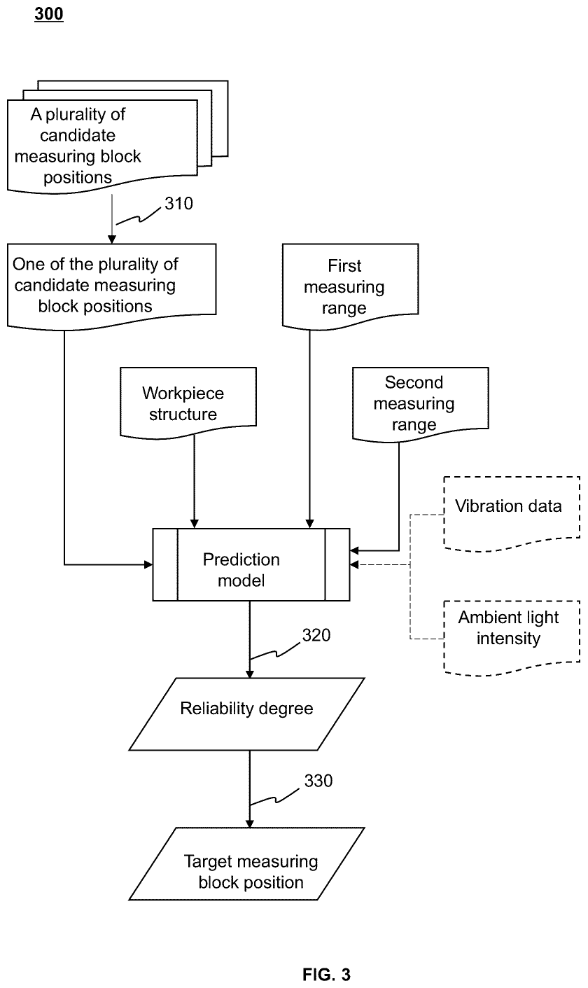

In some embodiments, the position of the measuring block may be determined in various ways. For example, the position of the measuring block may be predicted and determined using a prediction model. More descriptions of determining the position of the measuring block based on the prediction model may be found in FIG. 3 and the related descriptions thereof.

In some embodiments, a measurement coordinate system of the machine tool 110 may be denoted as O₀X₀Y₀Z₀, a measurement coordinate system of the first laser instrument 130 (i.e., a coordinate system in which the first laser instrument 130 is located) may be denoted as O₁X₁Y₁Z₁, and a measurement coordinate system of the second laser instrument 170 (i.e., a coordinate system in which the second laser instrument 170 is located) may be denoted as O₂X₂Y₂Z₂. For example, as shown in FIG. 1, in the measurement coordinate system of the machine tool 110, the X₀ axis is parallel to a height direction of the machine tool 110, the Y₀ axis is parallel to a length direction of the machine tool 110, the Z₀ axis is parallel to a width direction of the machine tool 110, and O₀ is a vertex at a top left corner of the machine tool 110.

The processing device may control the position adjustment mechanism to adjust a position of the first laser instrument 130 and a position of the second laser instrument 170, respectively, so that the X₁ axis, the Y₁ axis, and the Z₁ axis of the measurement coordinate system of the first laser instrument 130 and the X₂ axis, the Y₂ axis, and the Z₂ axis of the measurement coordinate system of the second laser instrument 170 are parallel to the X₀, Y₀, and Z₀ axes of the measurement coordinate system of the machine tool, respectively, and a measurement plane of the first laser instrument 130 and a measurement plane of the second laser instrument 170 are coplanar. O₁ may be a center point of the measurement plane of the first laser instrument 130, and O₂ may be a center point of the measurement plane of the second laser instrument 170.

Understandably, during the forming process of the workpiece 140, when a spatial position of the first laser instrument 130 and/or the second laser instrument 170 changes due to an external factor such as vibrations of the machine tool 110, the X₁, Y₁, and Z₁ axes of the measurement coordinate system of the first laser instrument 130 and/or the X₂, Y₂, and Z₂ axes of the measurement coordinate system of the second laser instrument 170 may not be entirely parallel to the X₀, Y₀, and Z₀ axes of the measurement coordinate system of the machine tool 110. However, the X₁ and Z axes lie on the measurement plane of the first laser instrument 130, and the Y₁ axis is perpendicular to the measurement plane of the first laser instrument 130. In addition, the X₂ and Z₂ axes lie on the measurement plane of the second laser instrument 170, and the Y₀ axis is perpendicular to the measurement plane of the second laser instrument 170.

In 220, at least one round of cyclic operations may be performed until a forming process of the workpiece ends, and a shape and a size of the workpiece during the forming process and a shape and a size of the workpiece after the forming process are obtained, respectively. In some embodiments, operation 220 may be performed by a cycling module 720.

In some embodiments, the processing device may perform the at least one round of cyclic operations at a preset time interval. The preset time interval refers to a pre-set time duration. For example, the preset time interval may be 1 s, 2 s, etc. An operator may send the preset time interval to the processing device or a storage device via a user terminal based on experience.

The end of the forming process of the workpiece refers to a state where the workpiece machining is completed, and a machining action stops.

The shape and the size of the processed workpiece refer to a contour and related dimensional data of the processed workpiece. For example, the shape and the size may be a cuboid with side lengths of b×c×d.

In some embodiments, each round of the at least one round of cyclic operations may include the following operations.

In 221, during the forming process of the workpiece, a plurality of pieces of point cloud data measured by the first laser instrument and the second laser instrument may be acquired, and point cloud data characterizing the measuring block in the plurality of pieces of point cloud data and point cloud data characterizing the workpiece in the plurality of pieces of point cloud data may be separated to obtain a first point cloud data set and a second point cloud data set measured by the first laser instrument, and to obtain a third point cloud data set and a fourth point cloud data set measured by the second laser instrument.

In some embodiments, operation 221 may be executed by an acquisition and separation sub-module 721.

The point cloud data refers to a discrete data set composed of a series of three-dimensional coordinate points. Each coordinate point, including coordinate values in an X direction, a Y direction, and a Z direction, is used to describe a geometric characteristic of an object (e.g., the workpiece), such as a surface shape, a spatial position, a size, or the like. In some embodiments, the multiple pieces of point cloud data obtained by the first laser instrument and the second laser instrument may respectively include workpiece point cloud data, measuring block point cloud data, and unrecognized region point cloud data.

The workpiece point cloud data, the measuring block point cloud data, and the unrecognized region point cloud data refer to sets of point cloud data that may reflect the surface shape, spatial position, size, or the like of the workpiece, the measuring block, and the unrecognized region, respectively. The unrecognized region refers to a region that neither belongs to the workpiece nor to the measuring block.

In some embodiments, the processing device may obtain the plurality of pieces of point cloud data through measurement using the first laser instrument and the second laser instrument.

The first point cloud data set refers to a first side point cloud data set of the measuring block in a coordinate system in which the first laser instrument is located. The second point cloud data set refers to a first side point cloud data set of the workpiece in the coordinate system in which the first laser instrument is located. The third point cloud data set refers to a second side point cloud data set of the measuring block in a coordinate system in which the second laser instrument is located. The fourth point cloud data set refers to a second side point cloud data set of the workpiece in the coordinate system in which the second laser instrument is located. The coordinate system in which the first laser instrument is located is O₁X₁Y₁Z₁, and the coordinate system in which the second laser instrument is located is O₂X₂Y₂Z₂.

In some embodiments, the processing device may obtain the first point cloud data set and the second point cloud data set through the first laser instrument. The processing device may obtain the third point cloud data set and the fourth point cloud data set through the second laser instrument. The first point cloud data set may also be referred to as an inner point cloud data set of the measuring block, and the second point cloud data set may also be referred to as an inner point cloud data set of the workpiece. The third point cloud data set may also be referred to as an outer point cloud data set of the measuring block, and the fourth point cloud data set may also be referred to as an outer point cloud data set of the workpiece.

The first side point cloud data set refers to a point cloud data set obtained by the first laser instrument on a side where the first laser instrument is located. For example, in the case of a spinning process, if an inner contour of the workpiece faces the first laser instrument, the first side point cloud data set may be a set of point cloud data reflecting the inner contour of the workpiece. The first side point cloud data set may also be referred to as an inner point cloud data set.

The second side point cloud data set refers to a point cloud data set obtained by the second laser instrument on a side where the second laser instrument is located. For example, in the case of a spinning process, if an outer contour of the workpiece faces the second laser instrument, the second side point cloud data set may be a set of point cloud data reflecting the outer contour of the workpiece. The second side point cloud data set may also be referred to as an outer point cloud data set.

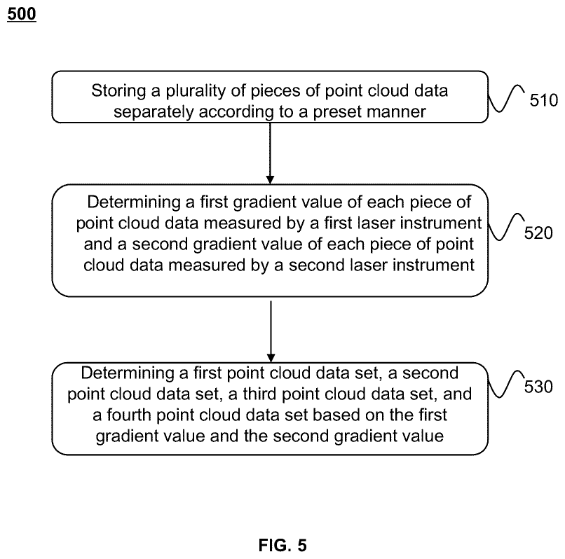

In some embodiments, the processing device may separate the point cloud data characterizing the measuring block and the point cloud data characterizing the workpiece in various ways to obtain the first point cloud data set, the second point cloud data set, the third point cloud data set, and the fourth point cloud data set. For example, the processing device may determine the first point cloud data set, the second point cloud data set, the third point cloud data set, and the fourth point cloud data set by determining a first gradient value and a second gradient value. More descriptions of determining the first gradient value and the second gradient value, and determining the first point cloud data set, the second point cloud data set, the third point cloud data set, and the fourth point cloud data set based on the first gradient value and the second gradient value may be found in FIG. 5 and the related descriptions thereof.

In 222, a rigid matching relationship of the measuring block may be generated based on the first point cloud data set and the third point cloud data set. In some embodiments, operation 222 may be executed by a first generation sub-module 722.

The rigid matching relationship refers to a translation and rotation relationship between the point cloud data in the first point cloud dataset and the point cloud data in the third point cloud dataset, in which no deformation is involved. The rigid matching relationship may also be referred to as a point cloud rigid matching relationship.

In some embodiments, the processing device may generate the rigid matching relationship based on the first point cloud data set, the third point cloud data set, and an amount of point cloud data in a point cloud data set of the measuring block.

In some embodiments, when two measuring surfaces of the measuring block are perpendicular to a measurement plane of the first laser instrument and a measurement plane of the second laser instrument, respectively, a standard thickness of the measuring block may be denoted as q.

When the two measuring surfaces of the measuring block are not perpendicular to the measurement planes of the first laser instrument and the second laser instrument, the processor may use calibration techniques such as an iterative closest point (ICP) algorithm to obtain a transformation relationship between the point cloud data of the first laser instrument and the point cloud data of the second laser instrument, thereby transferring first side point cloud data and second side point cloud data of a calibration object (e.g., the measuring block) to a same coordinate system (e.g., the coordinate system in which the first laser instrument is located or the coordinate system in which the second laser instrument is located). As a result, an average lateral distance of a measured region of the measuring block may be determined, denoted as p. The measured region of the measuring block includes a region measured by the first laser instrument and a region measured by the second laser instrument. When the two measuring surfaces of the measuring block are perpendicular to the measurement planes of the first laser instrument and the second laser instrument respectively, p equals q.

Since X-axis intervals of point cloud coordinates output by the first laser instrument and the second laser instrument are the same, based on a first edge point and a fourth edge point of the measuring block, the rigid matching relationship may be represented by Equation (1):

$${U}_{0} ( {x}_{i}^{( 0 )} , {y}_{i}^{( 0 )} ) ∼ {U}_{1} ( {x}_{m + 1 - i}^{( 1 )} , {y}_{m + 1 - i}^{( 1 )} ) , ( i = 1 , 2 , 3 … , m ) \qquad ( 1 )$$

wherein U₀(xᵢ⁽⁰⁾, yᵢ⁽⁰⁾) denotes the first point cloud data set, U₁(xₘ₊₁₋ᵢ⁽¹⁾, yₘ₊₁₋ᵢ⁽¹⁾) denotes the third point cloud data set, i denotes the index of any point cloud data in U₀(xᵢ⁽⁰⁾, yᵢ⁽⁰⁾) and m denotes the amount of point cloud data in the point cloud data set of the measuring block.

By way of example, when i=m, the point cloud data (xₘ⁽⁰⁾, yₘ⁽⁰⁾) in the first side point cloud data set of the measuring block measured by the first laser instrument measured, and the point cloud data (x₁⁽¹⁾, y₁⁽¹⁾) in the second side point cloud data set of the measuring block measured by the second laser instrument are both edge points of the measuring block. Additionally, since the X-axis intervals of the point cloud coordinates output by the first laser instrument and the second laser instrument are the same, if i takes a value (denoted as s) other than m, U₀(xₛ⁽⁰⁾, yₛ⁽⁰⁾) and U₁(xₘ₊₁₋ₛ⁽¹⁾, yₘ₊₁₋ₛ⁽¹⁾) may have a one-to-one correspondence. Here, s<m.

More descriptions of the first edge point and the fourth edge point may be found in FIG. 5 and the related descriptions.

Understandably, since it is ensured prior to measurement that there is no deviation in the Z-direction within a measurement region, under a condition that the first fixing mechanism and the second fixing mechanism do not move relative to each other along the Z-axis, Z-axis coordinates are not needed. The measured data are all two-dimensional data in the XOY plane.

In 223, a coordinate system relationship between the first laser instrument and the second laser instrument may be generated based on the rigid matching relationship. In some embodiments, operation 223 may be executed by a second generation sub-module 723.

The coordinate system relationship refers to a positional relationship between the measurement coordinate system of the first laser instrument and the measurement coordinate system of the second laser instrument. The coordinate system relationship may also be referred to as a measurement coordinate system positional relationship.

In some embodiments, the processing device may generate the coordinate system relationship based on the rigid matching relationship using the ICP algorithm.

The ICP algorithm is an iterative algorithm mainly used for precise alignment of depth images in computer vision. By iteratively minimizing a correspondence between source data and target data, the ICP algorithm achieves accurate alignment, offering advantages of fast computation and convenient operation. The ICP algorithm does not require segmentation or feature extraction of point clouds, and it exhibits good accuracy and convergence under a favorable initial condition.

In some embodiments, the processing device may generate a first distance between a Y-axis of the coordinate system in which the first laser instrument is located and a Y-axis of the coordinate system in which the second laser instrument is located and a second distance between an X-axis of the coordinate system in which the first laser instrument is located and an X-axis of the coordinate system in which the second laser instrument is located based on the first point cloud data set, the third point cloud data set, and a distance between the two measuring surfaces of the measuring block.

For example, the processing device may determine the coordinate system relationship between the first laser instrument and the second laser instrument based on Equations (2) and (3):

$$a = arg {min}_{a} {\sum }_{i = 1}^{m} {( {x}_{i}^{( 0 )} + {x}_{m + 1 - i}^{( 1 )} - a )}^{2} \qquad ( 2 )$$

$$b = arg {min}_{b} {\sum }_{i = 1}^{m} {( {y}_{i}^{( 0 )} + {y}_{m + 1 - i}^{( 1 )} - h - b )}^{2} \qquad ( 3 )$$

wherein a denotes the first distance, b denotes the second distance, U₀(xᵢ⁽⁰⁾, yᵢ⁽⁰⁾) denotes the first point cloud data set, i denotes the index of any point cloud data in U₀(xᵢ⁽⁰⁾, yᵢ⁽⁰⁾), U₁(xₘ₊₁₋ᵢ⁽¹⁾, yₘ₊₁₋ᵢ⁽¹⁾) denotes the third point cloud data set, m denotes the amount of point cloud data in the point cloud data set of the measuring block, and h denotes the distance between the two measuring surfaces of the measuring block. The coordinate system relationship between the first laser instrument and the second laser instrument obtained based on Equations (2) and (3) is more accurate.

It may be understood that when the two measuring surfaces of the measuring block are perpendicular to the measuring plane of the first laser instrument and the measuring plane of the second laser instrument, the standard thickness q of the measuring block is determined as the aforementioned distance h between the two measuring surfaces of the measuring block. When the two measuring surfaces of the measuring block are not perpendicular to the measuring plane of the first laser instrument and the measuring plane of the second laser instrument, the average lateral distance p is determined as the distance h between the two measuring surfaces of the measuring block.

In 224, the fourth point cloud data set may be converted into a fifth point cloud data set based on the coordinate system relationship. In some embodiments, operation 224 may be executed by a conversion sub-module 724.

The fifth point cloud data set refers to the second side point cloud data set of the workpiece in the coordinate system in which the first laser instrument is located. The fifth point cloud data set may also be referred to as the point cloud data set of the outer contour of the workpiece in the coordinate system of the first laser instrument. It may be understood that since the fourth point cloud data set is obtained by the second laser instrument and represents the point cloud data set of a side of the workpiece where the second laser instrument is located, the first laser instrument may not obtain the complete point cloud data set of this side of the workpiece. Therefore, it is necessary to convert the fourth point cloud data set into the coordinate system of the first laser instrument so that both the first side point cloud data set and the second side point cloud data set of the workpiece are in the coordinate system in which the first laser instrument is located, thereby generating the shape and the size of the workpiece.

In some embodiments, the processing device may generate the fifth point cloud data set based on the fourth point cloud data set, the first distance, and the second distance. A transverse coordinate of one point in the fourth point cloud data set may be inversely proportional to a transverse coordinate of a corresponding point in the fifth point cloud data set and proportional to the first distance, and a longitudinal coordinate of one point in the fourth point cloud data set may be inversely proportional to a longitudinal coordinate of a corresponding point in the fifth point cloud data set and proportional to the second distance. More descriptions of the first distance and the second distance may be found in the preceding related descriptions.

For example, the processing device may determine the fifth point cloud data set based on Equations (4) and (5):

$${x}_{i}^{( {3}^{′} )} = - {x}_{n + 1 - i}^{( 3 )} + a \qquad ( 4 )$$

$${y}_{i}^{( {3}^{′} )} = - {y}_{n + 1 - i}^{( 3 )} + b \qquad ( 5 )$$

wherein a denotes the first distance, b denotes the second distance, U₃(xᵢ⁽³⁾, yᵢ⁽³⁾) the fourth point cloud data set, U₃(xᵢ^{(3′)}, yᵢ^{(3′)}) denotes the fifth point cloud data set, i denotes the index of any point cloud data in U₃(xᵢ^{(3′)}, yᵢ^{(3′)}), and n denotes the amount of point cloud data in the point cloud data set of the workpiece.

In 225, an intermediate shape and an intermediate size of the workpiece may be generated based on the second point cloud data set and the fifth point cloud data set. In some embodiments, operation 225 may be executed by a third generation sub-module 725.

The intermediate shape and the intermediate size refer to the shape and the size of the workpiece during the machining process, i.e., the intermediate shape and the intermediate size may represent the shape and the size of the workpiece before it is fully formed.

In some embodiments, the second point cloud data set is the first side point cloud data set of the workpiece in the coordinate system in which the first laser instrument is located, and the fifth point cloud data set is the second side point cloud data set of the workpiece in the coordinate system in which the first laser instrument is located. Both the second point cloud data set and the fifth point cloud data set are located in the coordinate system of the first laser instrument. Therefore, the processing device may extract the intermediate shape and the intermediate size of the workpiece from the second cloud data set and the fifth point cloud data set through a point cloud fusion technique (e.g., surface reconstruction, voxel gridization, etc.).

In 226, whether the forming process has ended may be determined.

In some embodiments, in response to determining that the forming process has ended, the processing device may proceed to operation 230. In some embodiments, in response to determining that the forming process has not ended, the processing device may execute operations 221 to 225.

In 230, a shape and a size of the workpiece during the forming process and a shape and a size of the workpiece after the forming process may be obtained, respectively.

In some embodiments, in response to determining that the forming process has ended, the processing device may designate the intermediate shape and the intermediate size obtained from each round of the at least one round of cyclic operations, and the final shape and size of the workpiece after the forming process has ended, as the shape and the size of the workpiece during and after the forming process.

Some embodiments of the present disclosure provide a method for online measurement of a binocular laser system. The method continuously mounts a measuring block on the binocular laser system, uses the standard thickness of the measuring block to calibrate the positional relationship between the first laser instrument and second laser instrument, and synchronously performs measurement (i.e., operations 224-225) and calibration (i.e., operations 221-223). Throughout the forming process of the workpiece, at least one round of cyclic operations are performed, thereby achieving real-time calibration of the point cloud coordinate transformation relationship during the forming process. The method can improve the measurement accuracy of the binocular laser system, which is significant for achieving high-precision measurement during industrial production and can be widely applied. The method realizes real-time calibration of the point cloud data transformation relationship between the first laser instrument and second laser instrument during the forming process of the workpiece, which can eliminate deviations in the coordinate transformation relationship of point cloud data caused by spatial position changes of the two laser instruments due to machine tool vibration, thereby improving the measurement accuracy of the binocular laser system.

Furthermore, in some embodiments of the present disclosure, since measurement and calibration are performed synchronically, it ensures that both measurement and calibration are performed under a same external lighting condition. Therefore, the above method may can eliminate deviations in the pre-calibrated coordinate transformation relationship of the two laser instruments caused by sensitivity of the two laser instruments to lighting conditions, thereby improving the measurement accuracy of the binocular laser system. In some embodiments of the present disclosure, measurement and calibration are performed synchronically, allowing all subsequent calibrations to be carried out after the installation of the measuring block, eliminating the need for repetitive disassembly and installation of the measuring block, making the operation simple and avoiding the inconvenience of calibration before measurement and a cumbersome process of removing and installing the measuring block for each calibration when calibration and measurement are two separate processes.

It should be noted that the descriptions of the process of the method for online measurement of the binocular laser system provided above are for illustration purposes only, and do not limit the scope of the present disclosure. For those skilled in the art, various modifications and changes may be made to the process under the guidance of the present disclosure. However, these modifications and changes are still within the scope of the present disclosure.

In some embodiments, the processing device may emit lasers at a same preset frequency.

The preset frequency refers to a frequency set in advance. In some embodiments, the processing device may determine the preset frequency based on a sub-complexity degree of the workpiece during the forming process. The preset frequency refers to a pre-set frequency at which the first laser instrument and the second laser instrument emit lasers. For example, the preset frequency may be 3.846×10¹⁴ Hz.

In some embodiments, the processing device may divide the entire forming process into multiple sub-stages based on the shape of the workpiece. For each sub-stage, the processing device may determine the preset frequency of the sub-stage based on the sub-complexity degree of the sub-stage. In some embodiments, the sub-complexity degree of the sub-stage may be positively correlated with the preset frequency of the sub-stage.

In some embodiments, the multiple sub-stages may be manually divided by personnel in the field based on the complexity degree of the workpiece during the forming process. It should be noted that the personnel may group processes with similar complexity degrees into a same sub-stage.

The sub-complexity degree refers to an indicator for characterizing complexity of the shape and the size of the workpiece in each sub-stage during the forming process.

In some embodiments, the sub-complexity degree may be positively proportional to a count of surfaces and a count of angles of a workpiece structure in the sub-stage. For example, the processing device may sum the count of surfaces and the count of angles of the workpiece structure in the sub-stage, and designate a result of the summation as the sub-complexity of the sub-stage. For example, if the shape of the workpiece in a sub-stage is a triangular pyramid, and the workpiece includes four surfaces and four angles, then the sub-complexity degree of the sub-stage may be determined as 8 (i.e., 4+4=8).

In some embodiments, the processing device may determine the preset frequency by querying a preset frequency correspondence table. The preset frequency correspondence table may be determined by the personnel in the field based on empirical values.

Based on the sub-complexity degree of the workpiece in the forming process, the preset frequency may be determined. The higher the sub-complexity degree is, the higher the preset frequency is correspondingly, thus a higher density of point cloud data can be obtained, which facilitates obtaining the shape and the size of a highly complex workpiece more accurately.

FIG. 3 is a schematic diagram of an exemplary process for determining a target measuring block position based on a prediction model according to some embodiments of the present disclosure. As shown in FIG. 3, process 300 includes the following operations. In some embodiments, one or more operations of process 300 shown in FIG. 3 may be implemented in the binocular laser system 100 shown in FIG. 1. For example, process 300 shown in FIG. 3 may be stored in a storage device in the form of instructions and called and/or executed by a processing device. In some embodiments, process 300 may be executed by the mounting module 710.

In 310, a plurality of candidate measuring block positions may be generated.

A candidate measuring block position refers to a position where the measuring block may be placed. In some embodiments, the processing device may represent the plurality of candidate measuring block positions by spatial coordinates in a measurement coordinate system of a machine tool. For example, a candidate measuring block position may be located at (1, 2, 3) in an O₀X₀Y₀Z₀ measurement coordinate system, i.e., X₀=1, Y₀=2, Z₀=3.

In some embodiments, the processing device may randomly generate the plurality of candidate measuring block positions. For example, the processing device may randomly generate a certain count of candidate measuring block positions within at least one region provided by personnel in the field.

In 320, for one of the plurality of candidate measuring block positions, a reliability degree of the candidate measuring block position may be determined based on the candidate measuring block position, a workpiece structure, a first measuring range, and a second measuring range through a prediction model.

The reliability degree refers to a numerical or alphabetical value used to characterize the usefulness of a first point cloud data set and a third point cloud data set collected based on the candidate measuring block position in determining a coordinate system relationship between a first laser instrument and a second laser instrument.

The prediction model is a model for predicting the reliability degree of the candidate measuring block position. In some embodiments, the prediction model may be a machine learning model, for example, a deep neural networks (DNN) model, a support vector machines (SVM) model, etc.

In some embodiments, an input of the prediction model may include the candidate measuring block position, the workpiece structure, the first measuring range, and the second measuring range, and an output of the prediction model may include the reliability degree of the candidate measuring block position.

The workpiece structure refers to relevant parameter(s) reflecting the construction of the workpiece. In some embodiments, the processing device may retrieve the workpiece structure by accessing a structure design diagram of the workpiece stored in the storage device. The structure design diagram may be input by the personnel in the field through a user terminal and stored in the storage device.

The first measuring range refers to a measuring range of the first laser instrument, and the second measuring range refers to a measuring range of the second laser instrument. In some embodiments, the processing device may access an instrument parameter file of the first laser instrument and the second laser instrument to obtain the first measuring range and the second measuring range. More descriptions of the first laser instrument and the second laser instrument may be found in FIG. 1 and the related descriptions thereof.

In some embodiments, when the binocular laser system is provided with a vibration sensor, the input of the prediction model may include vibration data during a forming process of the workpiece. Since vibrations of the machine tool during the forming process of the workpiece may cause spatial position changes of a device such as a laser instrument (e.g., the first laser instrument or the second laser instrument), which may affect validity of collected point cloud data, inputting the vibration data during the forming process of the workpiece into the prediction model can improve accuracy of the model prediction.

In some embodiments, when the binocular laser system is provided with a light detection device, the input of the prediction model may include an ambient light intensity during the forming process of the workpiece. More descriptions of the vibration sensor and the light detection device may be found in FIG. 1 and the related descriptions thereof.

Since the laser instrument obtains a point cloud coordinate of a surface of an object by identifying a position of a laser spot reflected from the surface of the object in a sensor, the point cloud coordinate obtained by the laser instrument is related to a ambient lighting condition, i.e., the laser instrument is sensitive to lighting conditions. Different external lighting conditions during measurement may result in different point cloud coordinates of the surface of the object obtained by the laser instrument, which may affect the validity of the collected point cloud data. Therefore, inputting the ambient light intensity into the prediction model can improve the accuracy of the model prediction.

In some embodiments, the processing device may train an initial prediction model based on a large number of labeled training samples to obtain the prediction model. The training samples may include sample measuring block positions, sample workpiece structures, sample first measuring ranges, and sample second measuring ranges. The labels may include sample reliability degrees corresponding to the sample measuring block positions.

In some embodiments, if the input of the prediction model includes the vibration data during the forming process of the workpiece and/or the ambient light intensity during the forming process of the workpiece, the training samples may also include sample vibration data and/or sample ambient light intensities.

In some embodiments, the processing device may input a plurality of labeled training samples into the initial prediction model, construct a loss function based on the labels and the output a result of the initial prediction model, and iteratively update a parameter of the initial prediction model based on the loss function through gradient descent or other techniques. When a preset conditions is satisfied, the model training is completed, and a trained prediction model is obtained. The preset condition may include the loss function converging, a count of iterations reaching a threshold, or the like.

In some embodiments, the processing device may obtain the plurality of training samples based on historical data and determine the sample reliability degree corresponding to the sample measuring block position based on a historical working condition of the sample measuring block position. The historical working condition refers to relevant data reflecting the working process of the sample measuring block position. For example, the historical working conditions may include whether the sample measuring block position interferes with the forming process of the workpiece, a proportion of useful data collected in multiple point cloud data sets from the sample measuring block position, or the like.

In some embodiments, in response determining that the sample measuring block position interferes with the forming process of the workpiece, the processing device may mark the label as 0. In some embodiments, in response to determining that the sample measuring block position does not interfere with the forming process of the workpiece, the processing device may determine the reliability degree corresponding to the sample measuring block position based on an amount of workpiece point cloud data, an amount of measuring block point cloud data, and an amount of unrecognized region point cloud data.

The reliability degree is proportional to the amount of workpiece point cloud data and the amount of measuring block point cloud data, and inversely proportional to the amount of unrecognized region point cloud data. For example, the processing device may determine reliability degree using Equation (6):

$$H = \frac{S + P}{S + P + Q} \times 100 \% \qquad ( 6 )$$

wherein S denotes the amount of workpiece point cloud data, P denotes the amount of measuring block point cloud data, Q denotes to the amount of unrecognized region point cloud data, and H denotes the reliability degree.

In some embodiments, the processing device may divide the plurality of training samples into multiple different complexity intervals based on a complexity degree of the sample workpiece structure in each training sample. In other words, a complexity interval may include multiple training samples with sample workpiece structures having similar complexity degrees.

The complexity degree of the sample workpiece structure refers to a numerical or alphabetical value reflecting complexity of a shape and contour of the sample workpiece structure. The manner of determining the complexity degree is similar to the determination of the sub-complexity degree, which may be found in FIG. 2 and the related descriptions thereof.

A complexity interval refers to a range of complexity degree values, for example, complexity intervals such as [1-5], [6-10], etc. An average complexity degree refers to a numerical or alphabetical value reflecting complexity of the complexity interval. In some embodiments, the average complexity degree may be characterized in multiple ways, for example, a median of the complexity interval may represent the average complexity degree. By way of example, if the complexity interval is [1-5], then the average complexity degree of the complexity interval may be 3.

In some embodiments, different complexity intervals may correspond to different counts of training samples, and the count of training samples corresponding to each complexity interval is positively correlated with the average complexity degree of the complexity interval. By way of example, if the average complexity degree of a complexity interval [1-5] is 3 and the average complexity degree of a complexity interval [6-10] is 8, then the count of training samples included in the complexity interval [1-5] is less than the count of training samples included in the complexity interval [6-10].

In some embodiments, the count of training samples included in different complexity intervals may be obtained by the personnel in this field through a preset table based on the average complexity degree. The preset table may be constructed by the personnel in this field based on empirical values and historical data, and may include a corresponding relationship between average complexity degrees and counts of training samples.

In 330, a target measuring block position may be determined based on the reliability degrees of the plurality of candidate measuring block positions.

The target measuring block position refers to a position where the measuring block is placed during the actual forming process of the workpiece.

In some embodiments, the processing device may sort the reliability degrees of the plurality of candidate measuring block positions and select a candidate measuring block position with a highest reliability degree as the target measuring block position.

By obtaining the reliability degrees of the plurality of candidate measuring block positions through the prediction model and determining the target measuring block position based on the reliability degrees, a more optimal position for placing the measuring block can be selected efficiently and intelligently, thereby ensuring effectiveness of point cloud data and further improving the measurement accuracy of the binocular laser system.

It should be noted that the descriptions of the process for online measurement of the binocular laser system above are for illustration purposes only, and do not limit the scope of the present disclosure. For those skilled in the art, various modifications and changes may be made to the process under the guidance of the present disclosure. However, these modifications and changes are still within the scope of the present disclosure.

FIG. 5 is a flowchart of an exemplary process for determining a first point cloud data set, a second point cloud data set, a third point cloud data set, and a fourth point cloud data set according to some embodiments of the present disclosure. As shown in FIG. 5, process 500 includes the following operations. In some embodiments, one or more operations of process 500 shown in FIG. 5 may be implemented in the binocular laser system 100 shown in FIG. 1. For example, process 500 shown in FIG. 5 may be stored in a storage device in the form of instructions and called and/or executed by a processing device. In some embodiments, process 500 may be implemented by the acquisition and separation sub-module 721.

In 510, a plurality of pieces of point cloud data may be stored separately according to a preset manner.

The preset manner refers to a manner used to store the plurality of pieces of point cloud data.

In some embodiments, the preset manner may be determined in various ways. For example, the preset manner may include a manner where X-axis coordinate values are sorted in an ascending order.

In some embodiments, the preset manner may include a method where the X-axis coordinate values are in ascending order. For illustration purposes, the following describes an example where the preset manner is associated with an ascending order of X-axis coordinate values.

In 520, a first gradient value of each piece of the point cloud data measured by a first laser instrument and a second gradient value of each piece of the point cloud data measured by a second laser instrument may be determined.

The first gradient value reflects a rate of change of the point cloud data obtained by the first laser instrument.

The second gradient value reflects a rate of change of the point cloud data obtained by the second laser instrument.

In some embodiments, the first gradient value and the second gradient value may be determined in a same way. The processing device may select, among three consecutive neighboring points, a point with a smallest X-axis coordinate value as a first point and a point with a largest X-axis coordinate value as a second point, determine a slope between the first point and the second point, and designate the slope as a gradient value (e.g., the first gradient value or the second gradient value) of an intermediate point. The neighboring points of a point refer to points that are closest to that point in a straight line.

For example, the processing device may determine the first gradient value based on Equation (7):

$${G}_{i} = ( {y}_{i + 1} - {y}_{i - 1} ) / ( {x}_{i + 1} - {x}_{i - 1} ) , i = 2 , 3 … , p - 1 \qquad ( 7 )$$

wherein i denotes the index of a piece of point cloud data obtained by a laser instrument (e.g., the first laser instrument or the second laser instrument), p denotes a total count of pieces of point cloud data obtained by the laser instrument, Gi denotes the gradient value of an i-th point, (xᵢ₊₁, yᵢ₊₁) denotes a coordinate of an (i+1)-th point, and (xᵢ₋₁, yᵢ₋₁) denotes a coordinate of an (i−1)-th point. It should be noted that the first gradient value of two points at an outermost periphery of the measuring range of the laser measurement is not determined.

By determining the slope between neighboring points as the gradient value for the intermediate point, it is possible to accurately reflects a trend of change for each piece of point cloud data, allowing for a reasonable determination of the position of the points, which aids in accurately identifying object coordinates corresponding to the points, assisting the system in recognizing the workpiece and the measuring block.

In 530, the first point cloud data set, the second point cloud data set, the third point cloud data set, and the fourth point cloud data set may be determined based on the first gradient value and the second gradient value.

More descriptions of the first point cloud data set, the second point cloud data set, the third point cloud data set, and the fourth point cloud data set may be found in FIG. 2 and the related descriptions thereof.

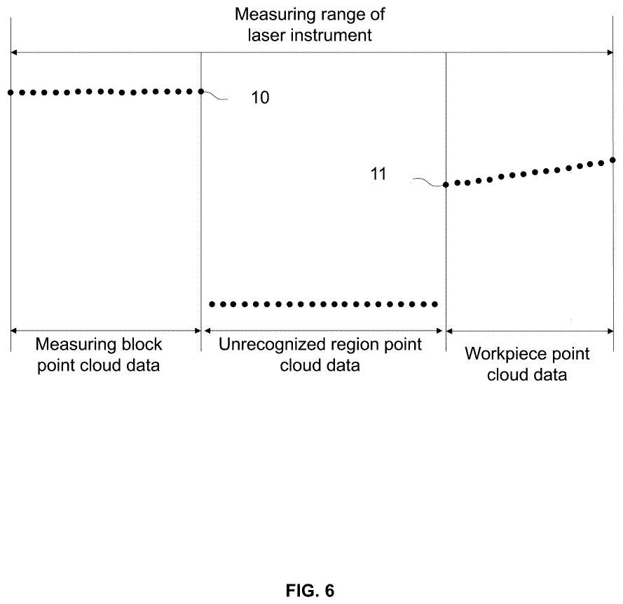

In some embodiments, as shown in FIG. 6, the processing device may identify point cloud data with a smallest first gradient value as an edge point of the measuring block, denoted as a first edge point 10. The processing device may identify point cloud data with a largest first gradient value as an edge point of the workpiece, denoted as a second edge point 11. The processing device may identify point cloud data with a smallest second gradient value as an edge point of the workpiece, denoted as a third edge point. The processing device may identify point cloud data with a largest second gradient value as an edge point of the measuring block, denoted as a fourth edge point. The edge point refers to the point that represents an edge position of a contour of the workpiece and the measuring block.

In some embodiments, the processing device may determine, among the plurality of pieces point cloud data measured by the first laser instrument, the first edge point 10 and point cloud data that is less than an X-axis coordinate value of the first edge point 10 as a first side point cloud data set (i.e., the first point cloud data set) of the measuring block, denoted as U₀(xᵢ⁽⁰⁾, yᵢ⁽⁰⁾).

The processing device may determine, among the plurality of pieces point cloud data measured by the first laser instrument, the second edge point 11 and point cloud data that is greater than an X-axis coordinate value of the second edge point 11 as a first side point cloud data set (i.e., the second point cloud data set) of the workpiece, denoted as U₂(xᵢ⁽²⁾, yᵢ⁽²⁾).

The processing device may determine, among the plurality of pieces of point cloud data measured by the second laser instrument, the fourth edge point and point cloud data that is less than an X-axis coordinate value of the fourth edge point as a second side point cloud data set (i.e., the fourth point cloud data set) of the measuring block, denoted as U₁(xᵢ⁽¹⁾, yᵢ⁽¹⁾).

The processing device may determine, among the plurality of pieces of point cloud data measured by the second laser instrument, a second side point cloud data set (i.e., the third point cloud data set) of the workpiece, denoted as U₃(xᵢ⁽³⁾, yᵢ⁽³⁾).

In some embodiments of the present disclosure, based on the first gradient value and the second gradient value the first edge point, the second edge point, the third edge point, and the fourth edge point can be obtained more accurately and quickly, facilitating accurate acquisition of the first point cloud data set, the second point cloud data set, the third point cloud data set, and the fourth point cloud data set, and effectively ensuring accuracy of the point cloud data sets.

It should be noted that the description of the process of online measurement by the binocular laser system provided above are for illustration purposes only, and do not limit the scope of the present disclosure. For those skilled in the art, various modifications and changes may be made to the process under the guidance of the present disclosure. However, these modifications and changes are still within the scope of the present disclosure.

In some embodiments, to facilitate the illustration of the real-time calibration method proposed in some embodiments of the present disclosure to improve the measurement accuracy of the binocular laser system, the following experiment was designed:

To compare the measurement accuracy of an existing calibration method and the method proposed in some embodiments of the present disclosure, a thickness of a billet was taken as a measurement target, and a difference between the thickness measured by the two methods and the actual thickness was compared. Firstly, a coordinate relationship between the first laser instrument and the second laser instrument was calibrated. Then, the cuboid billet was fixed on a core mold and rotated 50 revolutions. Next, according to the real-time calibration method proposed in some embodiments of the present disclosure, a transformation relationship between the point cloud data was obtained. Finally, using the transformation relationship obtained by the two methods, the point cloud data obtained by the two laser devices were transformed into the same coordinate system to obtain the thickness of the measuring block. The results are shown in Table 1:

TABLE 1
Results of real-time calibration methods

| | | | Method provided in some | | |
|---|---|---|---|---|---|
| | Existing calibration | | embodiments of the present | | |
| | method | | disclosure | | |
| Billet | | | | | Error |
| thickness | Measurement | Relative | Measurement | Relative | reduction |
| (mm) | result (mm) | error (%) | result (mm) | error (%) | (%) |
| 2 | 2.038 | 1.9 | 2.011 | 0.55 | 71.05 |
| 5 | 5.060 | 1.2 | 5.011 | 0.22 | 81.67 |
| 8 | 8.033 | 0.41 | 7.994 | 0.08 | 80.49 |

As seen from the table above, compared to the existing calibration method, the real-time calibration method proposed in some embodiments of the present disclosure greatly improves the measurement accuracy of the binocular laser system. The method provided in the present disclosure can provide support for autonomous optimization and real-time control of forming process parameters, enable intelligent forming and effectively enhancing the quality of workpiece formation, and can be widely applied in industrial production.

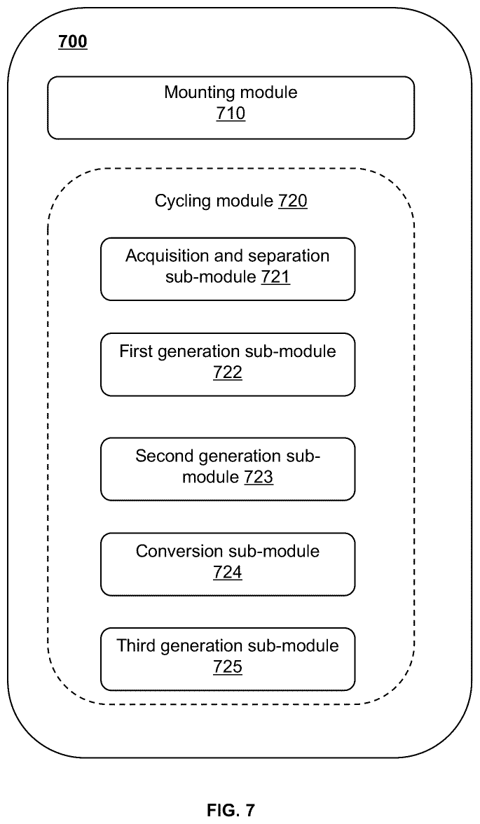

FIG. 7 is a schematic diagram of exemplary modules of a device for online measurement of a binocular laser system according to some embodiments of the present disclosure.

In some embodiments, a device 700 for online measurement of a binocular laser system may include a mounting module 710 and a cycling module 720.

The mounting module 710 is a module configured to mount a workpiece and a measuring block on the binocular laser system.

In some embodiments, the mounting module may be configured to mount a workpiece on the binocular laser system, provide a measuring block fixing mechanism on the binocular laser system, and mount a measuring block, such that a laser emitted from a first laser instrument and a laser emitted from a second laser instrument of the binocular laser system are projected onto two measuring surfaces of the measuring block, respectively, and a projection position of the laser emitted from the first laser instrument and a projection position of the laser emitted from the second laser instrument are maintained unchanged.

The cycling module 720 is a module configured to execute cyclic operations.

In some embodiments, the cycling module 720 may be configured to perform at least one round of cyclic operations until a forming process of the workpiece ends, and obtain a shape and a size of the workpiece during the forming process and a shape and a size of the workpiece after the forming process, respectively.

In some embodiments, the cycling module 720 may include an acquisition and separation sub-module 721, a first generation sub-module 722, a second generation sub-module 723, a conversion sub-module 724, and a third generation sub-module 725.

The acquisition and separation sub-module 721 is a module configured to acquire and separate point cloud data.

In some embodiments, the acquisition and separation sub-module 721 may be configured to acquire a plurality of pieces of point cloud data measured by the first laser instrument and the second laser instrument during the forming process of the workpiece, and separating point cloud data characterizing the measuring block in the plurality of pieces of point cloud data and point cloud data characterizing the workpiece in the plurality of pieces of point cloud data to obtain a first point cloud data set and a second point cloud data set measured by the first laser instrument, and to obtain a third point cloud data set and a fourth point cloud data set measured by the second laser. The first point cloud data set is a first side point cloud data set of the measuring block in a coordinate system in which the first laser instrument is located. The second point cloud data set is a first side point cloud data set of the workpiece in the coordinate system in which the first laser instrument is located. The third point cloud data set is a second side point cloud data set of the measuring block in a coordinate system in which the second laser instrument is located. The fourth point cloud data set is a second side point cloud data set of the workpiece in the coordinate system in which the second laser instrument is located.

In some embodiments, the acquisition and separation sub-module 721 may be further configured to store the plurality of pieces of point cloud data separately according to a preset manner; determine a first gradient value of each piece of the point cloud data measured by the first laser instrument and a second gradient value of each piece of the point cloud data measured by the second laser instrument; and determine the first point cloud data set, the second point cloud data set, the third point cloud data set, and the fourth point cloud data set based on the first gradient value and the second gradient value

In some embodiments, the plurality of pieces of point cloud data measured by the first laser instrument and the second laser instrument may respectively include workpiece point cloud data, measuring block point cloud data, and unrecognized region point cloud data.

In some embodiments, the preset manner is associated with an ascending order of X-axis coordinate values. The acquisition and separation sub-module 721 may be further configured to: identify point cloud data with a smallest first gradient value as an edge point of the measuring block, denoted as a first edge point; identify point cloud data with a largest first gradient value as an edge point of the workpiece, denoted as a second edge point; identify point cloud data with a smallest second gradient value as an edge point of the workpiece, denoted as a third edge point; identify point cloud data with a largest second gradient value as an edge point of the measuring block, denoted as a fourth edge point. The acquisition and separation sub-module 721 may be further configured to: among the plurality pieces of point cloud data measured by the first laser instrument, determine the first edge point and point cloud data that is less than an X-axis coordinate value of the first edge point as the first point cloud data set, and determine the second edge point and point cloud data that is greater than an X-axis coordinate value of the second edge point as the second point cloud data set. The acquisition and separation sub-module 721 may be further configured to: among the point cloud data measured by the second laser instrument, determine the third edge point and point cloud data that is less than an X-axis coordinate value of the third edge point as the fourth point cloud data set, and determine the fourth edge point and point cloud data that is greater than an X-axis coordinate value of the fourth edge point as the third point cloud data set.

In some embodiments, the preset manner may be associated with an ascending order of X-axis coordinate values. The acquisition and separation sub-module 721 may be further configured to determine, among three consecutive neighboring points, a slope between a second point and a first point as a gradient value of an intermediate point, the first point being a point with a smallest X-axis coordinate value and the second point being a point with a largest X-axis coordinate value.

The first generation sub-module 722 is a module configure to generate a rigid matching relationship.

In some embodiments, the first generation sub-module 722 may be configured to generate the rigid matching relationship based on the first point cloud data set and the third point cloud data set.

In some embodiments, the first generation sub-module 722 may be further configured to generate the rigid matching relationship based on the first point cloud data set, the third point cloud data set, and an amount of point cloud data in a point cloud data set of the measuring block.

The second generation sub-module 723 is a module configured to generate a coordinate system relationship.

In some embodiments, the second generation sub-module 723 may be configured to generate the coordinate system relationship between the first laser instrument and the second laser instrument based on the rigid matching relationship.

In some embodiments, the second generation sub-module 723 may be further configured to generate the coordinate system relationship based on the rigid matching relationship using an iterative closest point (ICP) algorithm.

In some embodiments, the second generation sub-module 723 may be further configured to generate a first distance between a Y-axis of the coordinate system in which the first laser instrument is located and a Y-axis of the coordinate system in which the second laser instrument is located and a second distance between an X-axis of the coordinate system in which the first laser instrument is located and an X-axis of the coordinate system in which the second laser instrument is located based on the first point cloud data set, the third point cloud data set, and a distance between the two measuring surfaces of the measuring block.

The conversion sub-module 724 is a module configured to convert point cloud data sets.

In some embodiments, the conversion sub-module 724 may be configured to convert the fourth point cloud data set into a fifth point cloud data set based on the coordinate system relationship, the fifth point cloud data set being a second side point cloud data set of the workpiece in the coordinate system in which the first laser instrument is located.

In some embodiments, the conversion sub-module 724 may be further configured to generate the fifth point cloud data set based on the fourth point cloud data set, a first distance, and a second distance, wherein a transverse coordinate of one point in the fourth point cloud data set is inversely proportional to a transverse coordinate of a corresponding point in the fifth point cloud data set and proportional to the first distance, and a longitudinal coordinate of one point in the fourth point cloud data set is inversely proportional to a longitudinal coordinate of a corresponding point in the fifth point cloud data set and proportional to the second distance.

The third generation sub-module 725 is a module configured to generate an intermediate shape and an intermediate size of the workpiece.

In some embodiments, the third generation sub-module 725 may be configured to, generate the intermediate shape and the intermediate size of the workpiece based on the second point cloud data set and the fifth point cloud data set.

More descriptions of the mounting module 710 and the cycling module 720 may be found in FIGS. 2-6 and the related descriptions thereof.

It should be understood that the device and its modules shown in FIG. 7 may be implemented in various ways. It should be noted that the descriptions of the device for online measurement of the binocular laser systems and its modules above is for convenience and do not limit the scope of the present disclosure to the embodiments provided. It may be understood that for those skilled in the art, after understanding the principles of the device, various modules may be arbitrarily combined or constituted as sub-devices connected to other modules without departing from these principles. In some embodiments, the mounting module 710 and the cycling module 720 disclosed in FIG. 7 may be different modules in a single system, or a single module implementing the functions of two or more of the above modules. For example, each module may share a storage module, or each module may have its own storage module. Such variations are within the scope of the present disclosure.

One embodiment of the present disclosure provides a method for improving accuracy of online measurement of a workpiece size using a binocular laser system, the method may include following operations.

A workpiece may be mounted on the binocular laser measurement system, a measuring block fixing mechanism may be provided on the binocular laser system, and a measuring block may be mounted, such that a laser emitted from a first laser profiler and a laser emitted from a second laser profiler of the binocular laser system are projected onto two measuring surfaces of the measuring block, respectively, and a projection position of the laser emitted from the first laser profiler and a projection position of the laser emitted from the second laser profiler are maintained unchanged.

At least one round of cyclic operations may be performed until a forming process of the workpiece ends, and all inner contour point cloud data sets and outer contour point cloud data sets of the workpiece during the forming process may be obtained.

The least one round of cyclic operations may include: a plurality of pieces of point cloud data measured by the first laser profiler and the second laser instrument during the forming process of the workpiece may be acquired, and point cloud data characterizing the measuring block in the plurality of pieces of point cloud data and point cloud data characterizing the workpiece in the plurality of pieces of point cloud data may be separated to obtain an inner contour point cloud data set of the measuring block and an inner contour point cloud data set of the workpiece measured by the first laser profiler, and to obtain an outer contour point cloud data set of the measuring block and an outer contour point cloud data set of the workpiece measured by the second laser profiler.

A point cloud rigid matching relationship of the measuring block may be obtained based on the inner contour point cloud data set and outer contour point cloud data set of the measuring block.

A coordinate system relationship of a measurement coordinate system of the first laser profiler and a measurement coordinate system of the second laser profiler may be obtained based on the point cloud rigid matching relationship.

The outer contour point cloud data set of the workpiece obtained by the second laser profiler may be converted into the outer contour point cloud data set of the workpiece in the measurement coordinate system of the first laser profiler based on the coordinate system relationship, and the shape and the size of the workpiece may be extracted from the inner contour point cloud data set and the outer contour point cloud data set of the workpiece.

One embodiment of the present disclosure provides a device for improving accuracy of online measurement of a workpiece size using a binocular laser system. The device may include a mounting module and a cycling module.

The mounting module may be configured to mount a workpiece on the binocular laser measurement system, provide a measuring block fixing mechanism on the binocular laser system, and mount a measuring block, such that a laser emitted from a first laser profiler and a laser emitted from a second laser profiler of the binocular laser system are projected onto two measuring surfaces of the measuring block, respectively, and a projection position of the laser emitted from the first laser instrument and a projection position of the laser emitted from the second laser instrument are maintained unchanged.

The cycling module may be configured to performing perform at least one round of cyclic operations until a forming process of the workpiece ends, and obtain all inner contour point cloud data sets and outer contour point cloud data sets of the workpiece during the formation process.

The cycling module may include an acquisition and separation sub-module, a first determination sub-module, a second determination sub-module, and a conversion and extraction sub-module. The acquisition and separation sub-module may be configured to acquire a plurality of pieces of point cloud data measured by the first laser instrument and the second laser instrument during the forming process of the workpiece, and separate point cloud data characterizing the measuring block in the plurality of pieces of point cloud data and point cloud data characterizing the workpiece in the plurality of pieces of point cloud data to obtain an inner contour point cloud data set of the measuring block and an inner contour point cloud data set of the workpiece measured by the first laser profiler, and to obtain an outer contour point cloud data set of the measuring block and an outer contour point cloud data set of the workpiece measured by the second laser profiler.

The first determination sub-module may be configured to obtain a rigid matching relationship of the measuring block based on the inner contour point cloud data set and outer contour point cloud data set of the measuring block.

The second determination sub-module may be configured to obtain a coordinate system relationship of a measurement coordinate system of the first laser profiler and a measurement coordinate system of the second laser profiler based on the point cloud rigid matching relationship.

The conversion and extraction sub-module may be configured to convert the outer contour point cloud data set of the workpiece obtained by the second laser profiler into the outer contour point cloud data set of the workpiece in the coordinate system of the first laser profiler based on the coordinate system relationship, and extract the shape and the size of the workpiece from the inner contour point cloud data set and the outer contour point cloud data set of the workpiece.

More descriptions of the binocular laser system, the inner contour point cloud data set, the outer contour point cloud data set, the inner contour point cloud data set of the measuring block, the inner contour point cloud data set of the workpiece, the outer contour point cloud data set of the measuring block, the outer contour point cloud data set of the workpiece, the point cloud rigid matching relationship, the coordinate system relationship, and the shape and the size of the workpiece may be found in FIGS. 1 to 7 and the related descriptions thereof.

One embodiment of the present disclosure provides a server, including a memory and a processor.

The memory is configured to store program instructions.

The processor is configured to execute the program instructions in the server, enabling the server to perform the method for online measurement of the binocular laser system described above.

One embodiment of the present disclosure provides a non-transitory computer-readable storage medium storing computer instructions, wherein when reading the computer instructions from the storage medium, a computer implements the method for online measurement of the binocular laser system described above.

In addition, features, structures, or characteristics of one or more embodiments described in the present disclosure may be appropriately combined.

If there is any inconsistency or conflict between the use of descriptions, definitions, and/or terms in the present disclosure and those referenced materials, the usage in the present disclosure shall prevail.

What is claimed is:

1. A method for online measurement of a binocular laser system, comprising:
mounting a workpiece on the binocular laser system, providing a measuring block fixing mechanism on the binocular laser system, and mounting a measuring block, such that a laser emitted from a first laser instrument and a laser emitted from a second laser instrument of the binocular laser system are projected onto two measuring surfaces of the measuring block, respectively, and a projection position of the laser emitted from the first laser instrument and a projection position of the laser emitted from the second laser instrument are maintained unchanged; and
performing at least one round of cyclic operations until a forming process of the workpiece ends, and obtaining a shape and a size of the workpiece during the forming process and a shape and a size of the workpiece after the forming process, respectively; wherein
each round of the at least one round of cyclic operations includes:
acquiring a plurality of pieces of point cloud data measured by the first laser instrument and the second laser instrument during the forming process of the workpiece, and separating point cloud data characterizing the measuring block in the plurality of pieces of point cloud data and point cloud data characterizing the workpiece in the plurality of pieces of point cloud data to obtain a first point cloud data set and a second point cloud data set measured by the first laser instrument, and to obtain a third point cloud data set and a fourth point cloud data set measured by the second laser instrument, wherein the first point cloud data set is a first side point cloud data set of the measuring block in a coordinate system in which the first laser instrument is located, the second point cloud data set is a first side point cloud data set of the workpiece in the coordinate system in which the first laser instrument is located, the third point cloud data set is a second side point cloud data set of the measuring block in a coordinate system in which the second laser instrument is located, and the fourth point cloud data set is a second side point cloud data set of the workpiece in the coordinate system in which the second laser instrument is located;
generating a rigid matching relationship of the measuring block based on the first point cloud data set and the third point cloud data set;
generating a coordinate system relationship between the first laser instrument and the second laser instrument based on the rigid matching relationship;
converting the fourth point cloud data set into a fifth point cloud data set based on the coordinate system relationship, the fifth point cloud data set being a second side point cloud data set of the workpiece in the coordinate system in which the first laser instrument is located; and
generating an intermediate shape and an intermediate size of the workpiece based on the second point cloud data set and the fifth point cloud data set.

2. The method of claim 1, wherein the separating point cloud data characterizing the measuring block in the plurality of pieces of point cloud data and point cloud data characterizing the workpiece in the plurality of pieces of point cloud data to obtain a first point cloud data set and a second point cloud data set measured by the first laser instrument, and to obtain a third point cloud data set and a fourth point cloud data set measured by the second laser instrument includes:
storing the plurality of pieces of point cloud data separately according to a preset manner;
determining a first gradient value of each piece of the point cloud data measured by the first laser instrument and a second gradient value of each piece of the point cloud data measured by the second laser instrument; and
determining the first point cloud data set, the second point cloud data set, the third point cloud data set, and the fourth point cloud data set based on the first gradient value and the second gradient value.

3. The method of claim 2, wherein the plurality of pieces of point cloud data measured by the first laser instrument and the second laser instrument respectively include workpiece point cloud data, measuring block point cloud data, and unrecognized region point cloud data.

4. The method of claim 2, wherein the preset manner is associated with an ascending order of X-axis coordinate values, and the determining the first point cloud data set, the second point cloud data set, the third point cloud data set, and the fourth point cloud data set based on the first gradient value and the second gradient value includes:
identifying point cloud data with a smallest first gradient value as an edge point of the measuring block, denoted as a first edge point; identifying point cloud data with a largest first gradient value as an edge point of the workpiece, denoted as a second edge point; identifying point cloud data with a smallest second gradient value as an edge point of the workpiece, denoted as a third edge point; identifying point cloud data with a largest second gradient value as an edge point of the measuring block, denoted as a fourth edge point;
among the plurality of pieces of point cloud data measured by the first laser instrument, determining the first edge point and point cloud data that is less than an X-axis coordinate value of the first edge point as the first point cloud data set, and determining the second edge point and point cloud data that is greater than an X-axis coordinate value of the second edge point as the second point cloud data set; and
among the plurality of pieces of point cloud data measured by the second laser instrument, determining the third edge point and point cloud data that is less than an X-axis coordinate value of the third edge point as the fourth point cloud data set, and determining the fourth edge point and point cloud data that is greater than an X-axis coordinate value of the fourth edge point as the third point cloud data set.

5. The method of claim 2, wherein the preset manner is associated with an ascending order of X-axis coordinate values, and the first gradient value and the second gradient value are determined in a same way, which includes:
determining, among three consecutive neighboring points, a slope between a second point and a first point as a gradient value of an intermediate point, the first point being a point with a smallest X-axis coordinate value and the second point being a point with a largest X-axis coordinate value.

6. The method of claim 1, wherein the generating a coordinate system relationship between the first laser instrument and the second laser instrument based on the rigid matching relationship includes:
generating the coordinate system relationship based on the rigid matching relationship using an iterative closest point (ICP) algorithm.

7. The method of claim 1, wherein the generating a coordinate system relationship between the first laser instrument and the second laser instrument based on the rigid matching relationship includes:
generating a first distance between a Y-axis of the coordinate system in which the first laser instrument is located and a Y-axis of the coordinate system in which the second laser instrument is located and a second distance between an X-axis of the coordinate system in which the first laser instrument is located and an X-axis of the coordinate system in which the second laser instrument is located based on the first point cloud data set, the third point cloud data set, and a distance between the two measuring surfaces of the measuring block.

8. The method of claim 1, wherein the generating a coordinate system relationship between the first laser instrument and the second laser instrument based on the rigid matching relationship includes:
generating the rigid matching relationship based on the first point cloud data set, the third point cloud data set, and an amount of point cloud data in a point cloud data set of the measuring block.

9. The method of claim 1, wherein the converting the fourth point cloud data set into a fifth point cloud data set based on the coordinate system relationship includes:
generating the fifth point cloud data set based on the fourth point cloud data set, a first distance, and a second distance, wherein a transverse coordinate of one point in the fourth point cloud data set is inversely proportional to a transverse coordinate of a corresponding point in the fifth point cloud data set and proportional to the first distance, and a longitudinal coordinate of one point in the fourth point cloud data set is inversely proportional to a longitudinal coordinate of a corresponding point in the fifth point cloud data set and proportional to the second distance.

10. A device for online measurement of a binocular laser system, comprising:
a mounting module configured to mount a workpiece on the binocular laser system, provide a measuring block fixing mechanism on the binocular laser system, and mount a measuring block, such that a laser emitted from a first laser instrument and a laser emitted from a second laser instrument of the binocular laser system are projected onto two measuring surfaces of the measuring block, respectively, and a projection position of the laser emitted from the first laser instrument and a projection position of the laser emitted from the second laser instrument are maintained unchanged;
a cycling module configured to perform at least one round of cyclic operations until a forming process of the workpiece ends, and obtain a shape and a size of the workpiece during the forming process and a shape and a size of the workpiece after the forming process, respectively;
wherein the cycling module includes:
an acquisition and separation sub-module configured to acquire a plurality of pieces of point cloud data measured by the first laser instrument and the second laser instrument during the forming process of the workpiece, and separate point cloud data characterizing the measuring block in the plurality of pieces of point cloud data and point cloud data characterizing the workpiece in the plurality of pieces of point cloud data to obtain a first point cloud data set and a second point cloud data set measured by the first laser instrument, and to obtain a third point cloud data set and a fourth point cloud data set measured by the second laser instrument, wherein the first point cloud data set is a first side point cloud data set of the measuring block in a coordinate system in which the first laser instrument is located, the second point cloud data set is a first side point cloud data set of the workpiece in the coordinate system in which the first laser instrument is located, the third point cloud data set is a second side point cloud data set of the measuring block in a coordinate system in which the second laser instrument is located, and the fourth point cloud data set is a second side point cloud data set of the workpiece in the coordinate system in which the second laser instrument is located;
a first generation sub-module configured to generate a rigid matching relationship of the measuring block based on the first point cloud data set and the third point cloud data set;
a second generation sub-module configured to generate a coordinate system relationship between the first laser instrument and the second laser instrument based on the rigid matching relationship;
a conversion sub-module configured to convert the fourth point cloud data set into a fifth point cloud data set based on the coordinate system relationship, the fifth point cloud data set being a second side point cloud data set of the workpiece in the coordinate system in which the first laser instrument is located; and
a third generation sub-module configured to generate an intermediate shape and an intermediate size of the workpiece based on the second point cloud data set and the fifth point cloud data set.

11. The device of claim 10, wherein the acquisition and separation sub-module is further configured to:
store the plurality of pieces of point cloud data separately according to a preset manner;
determine a first gradient value of each piece of the point cloud data measured by the first laser instrument and a second gradient value of each piece of the point cloud data measured by the second laser instrument; and
determine the first point cloud data set, the second point cloud data set, the third point cloud data set, and the fourth point cloud data set based on the first gradient value and the second gradient value.

12. The device of claim 11, wherein the plurality of pieces of point cloud data measured by the first laser instrument and the second laser instrument respectively include workpiece point cloud data, measuring block point cloud data, and unrecognized region point cloud data.

13. The device of claim 11, wherein the preset manner is associated with an ascending order of X-axis coordinate values, and the acquisition and separation sub-module is further configured to:
identify point cloud data with a smallest first gradient value as an edge point of the measuring block, denoted as a first edge point; identify point cloud data with a largest first gradient value as an edge point of the workpiece, denoted as a second edge point; identify point cloud data with a smallest second gradient value as an edge point of the workpiece, denoted as a third edge point; identify point cloud data with a largest second gradient value as an edge point of the measuring block, denoted as a fourth edge point;
among the plurality pieces of point cloud data measured by the first laser instrument, determine the first edge point and point cloud data that is less than an X-axis coordinate value of the first edge point as the first point cloud data set, and determine the second edge point and point cloud data that is greater than an X-axis coordinate value of the second edge point as the second point cloud data set; and
among the point cloud data measured by the second laser instrument, determine the third edge point and point cloud data that is less than an X-axis coordinate value of the third edge point as the fourth point cloud data set, and determine the fourth edge point and point cloud data that is greater than an X-axis coordinate value of the fourth edge point as the third point cloud data set.

14. The device of claim 11, wherein the preset manner is associated with an ascending order of X-axis coordinate values, the first gradient value and the second gradient value are determined in a same way, and the acquisition and separation sub-module is further configured to:
determine, among three consecutive neighboring points, a slope between a second point and a first point as a gradient value of an intermediate point, the first point being a point with a smallest X-axis coordinate value and the second point being a point with a largest X-axis coordinate value.

15. The device of claim 10, wherein the second generation sub-module is further configured to:
generate the coordinate system relationship based on the rigid matching relationship using an iterative closest point (ICP) algorithm.

16. The device of claim 10, wherein the second generation sub-module is further configured to:
generate a first distance between a Y-axis of the coordinate system in which the first laser instrument is located and a Y-axis of the coordinate system in which the second laser instrument is located and a second distance between an X-axis of the coordinate system in which the first laser instrument is located and an X-axis of the coordinate system in which the second laser instrument is located based on the first point cloud data set, the third point cloud data set, and a distance between the two measuring surfaces of the measuring block.

17. The device of claim 10, wherein the first generation sub-module is further configured to:
generate the rigid matching relationship based on the first point cloud data set, the third point cloud data set, and an amount of point cloud data in a point cloud data set of the measuring block.

18. The device of claim 10, wherein the conversion sub-module is further configured to:
generate the fifth point cloud data set based on the fourth point cloud data set, a first distance, and a second distance, wherein a transverse coordinate of one point in the fourth point cloud data set is inversely proportional to a transverse coordinate of a corresponding point in the fifth point cloud data set and proportional to the first distance, and a longitudinal coordinate of one point in the fourth point cloud data set is inversely proportional to a longitudinal coordinate of a corresponding point in the fifth point cloud data set and proportional to the second distance.

19. A non-transitory computer-readable storage medium storing computer instructions, wherein when reading the computer instructions from the storage medium, a computer implements the method for online measurement of a binocular laser system as claimed in claim 1.
